(19) United States
(12) Patent Application Publication
(10) Pub. No.: US 2002/0165898 A1
(43) Pub. Date: Nov. 7, 2002

(54) Recipient-determined method for sharing tasks in an advanced electronic messaging/workflow system

(76) Inventors: Joe Duffy, Madison, WI (US); Rajeev Gangwar, Madison, WI (US); Michael Vahldieck, Mazomanie, WI (US); Andy White, Madison, WI (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/115,689

(22) Filed: Apr. 4, 2002

Related U.S. Application Data
(60) Provisional application No. 60/288,479, filed on May 3, 2001.

(51) Int. Cl. G06F 9/00

(52) U.S. Cl. 709/102

(57) ABSTRACT

A method for sharing tasks, comprising: identifying a covered user, wherein the covered user is assigned one or more tasks; identifying a surrogate user that is associated with the covered user; identifying an unfinished task from the one or more tasks assigned to the covered user; creating a link for the surrogate user to the unfinished task assigned to the covered user; and providing the ability for the surrogate user to access the unfinished task via the link.

### CROSS-REFERENCE TO RELATED APPLICATIONS

This application claims priority to U.S. Provisional Application Serial No. 60/288,479, entitled “A Recipient-Determined Method For Sharing Tasks In An Advanced Electronic Messaging/Workflow System,” filed May 3, 2001 (attorney docket no. 29794/37354), the disclosure of which is hereby expressly incorporated herein by reference.

### TECHNICAL FIELD

The present patent relates to the management of messages and tasks using a computerized system, specifically to the sharing of messages and tasks using a recipient-determined model.

### BACKGROUND

As electronic messaging systems mature, they are progressing beyond offering basic e-mail functionality to handling an array of message types, which correspond to various types of tasks. In the event that a user of a system designed to utilize such a messaging system is absent from work, overburdened and incapable of responding to all available demands on that user's time, or otherwise unavailable, tasks sent to that user may not be completed in a timely manner, if at all.

Various existing solutions to such a scenario are based on the idea of redirection, effectively passing the tasks to another. Many messaging systems allow forwarding of messages to another user or group of users, but are limited in that they require direct action from the absent or overburdened user to pass the tasks to another. Advanced versions of this model allow various criteria to be established to automatically redirect incoming tasks from an absent or overburdened user to another user. In these advanced versions, the task is either copied to the intended recipient or may only appear for the user to whom it has been redirected.

There are a number of inherent difficulties in such a system; foremost among these is that the tasks are often redirected without proper consideration being given to the choice of recipient. The absent or overburdened user could send a new task to a user who lacks the proper context for completing the task, as is the case when the task relates to a previous task completed by the original user. Having the absent or overburdened user sort the tasks manually yields the most accurate results, but is time-consuming and often physically impossible.

Redirection of messages and tasks is, in itself, a problem. The decisions about how messages and tasks are redirected is made by either the user who is absent or overburdened, or by the system's own logic and rules. In either case, the process occurs without the recipient's involvement. Messages are divorced from a proper context, can be sent arbitrarily, and can assign work from one overburdened user to another. When tasks are redirected to more than one user, it can be difficult for the recipients to determine who should complete the task. If a user is incorrectly recorded as absent and tasks are incorrectly redirected, it can be difficult and time-consuming to retrieve the tasks for the original user. Most existing systems are based on a redirection model, and use technology similar to that for detecting junk e-mail to process incoming messages and tasks, using a set of rules and filters to redirect incoming tasks away from an absent or overburdened user. Such a set of rules may become very complex, as users attempt to customize a redirection system to meet their needs.

Microsoft Outlook serves as a popular example of a method for distributing tasks using a rules-based redirection model. Outlook allows users to designate themselves as “Out of Office.” This can be done on-the-fly, or rules can be established to create a scheduled Out of Office period. Outlook can provide an “Out of office Auto-Reply” message to users who send messages to the absent user. A variety of rules can be established to redirect e-mail, appointment requests, entries for the Taskpad, and other messages while the covered user is designated ‘out of office.’ Outlook rules can filter incoming messages based on sender, recipient, subject, message text, message size, sent date, and presence of attachments, and can move, copy, forward, delete, or reply to incoming messages based on the filtering criteria. In general, Outlook may require extensive setup to distribute messages accurately, and does not support some concepts crucial to effectively sharing work, such as providing a way to ensure that multiple recipients of a redirected task do not all complete the task.

Outlook also offers the ability to record delegates for a given user, which allows the delegates to access that user's e-mail, calendar, and other information, and respond to messages on behalf of the user. A similar feature configures Outlook to open additional mailboxes, causing them to appear in the user interface as though they were the user's mailbox. There is no integrated scheduling, and the design does not support on-the-fly adjustments or connections. In Outlook's model, the covered user must set permissions for each user prior to an absence. Neither a user planning an absence nor a user wishing to assume an absent user's work has the ability to both set permissions and open additional mailboxes, it does not allow either user to create a linked copy of messages and tasks for a surrogate user. There is no ability to schedule occasions for Outlook to open additional mailboxes and does not allow users to schedule multiple occasions. While Outlook provides some action-oriented security, in the form of permissions that control a user's ability to add, edit, and delete information in the additional mailboxes, it does not provide both action-oriented security to limit the user's actions in a linked copy to those normally available to the user, or content-oriented security based on the types of message or tasks included in the linked copy for each surrogate user.

With regard to handing the tasks of an absent or overburdened user, Outlook adopts a very active stance, filtering incoming messages and dealing with them according to a set of rules that can quickly grow in complexity. Recipients of redirected tasks have little ability to coordinate efforts and manage their incoming workloads.

Another attempted solution offered a module for distributing messages for an absent or overburdened user that also used a redirection model. This solution, which only applied to a limited range of message types for users, could redirect incoming messages for absent or overburdened users to designated recipients. This system, based on the redirection model, was too limited in scope (it did not redirect messages for other types of functionality), and too difficult to manage. Users had difficulty setting up schedules for being absent or overburdened, while administrators could not react effectively to user absences. On-the-fly functionality, such that users or administrators could quickly set up an arrangement for redirecting work, was absent. In general, neither end users nor administrators had enough power to manage workflows.

The following weaknesses with the existing systems were identified:

(1) There was no way to specify multiple occasions when a user's work will need to be covered by surrogates.

(2) Users other than the absent or overburdened user could not enter or edit occasions for that user. There was no way for a supervisor to mark a user as absent when they were ill or otherwise unavailable.

(3) When users left the organization, certain information would still be sent to these users, and other users could not see it. For example, results of medical tests were routed to providers who were only at a hospital for a short time.

(4) There was no feedback to the absent or overburdened user regarding work done on the user's behalf.

(5) Tasks could be sent to a pool of recipients. When a user was absent or overburdened, tasks sent to that user as a member of a pool were also sent directly to the surrogate user, creating the possibility of duplicated work.

(6) Redirection did not operate retroactively, so messages sent to an absent or overburdened user prior to the initiation of redirection were not redirected or shared. Redirection schemes could not be used to help a user deal with a backlog of work.

(7) The set of message types being redirected were not customizable, and the pre-determined set of messages was not wide-reaching enough to be useful for people in all roles.

(8) Work from an absent or overburdened user could not be sent to multiple surrogate recipients.

(9) Concerns also exist about the security of messages and tasks. In general, redirection models did not respect security considerations. Sensitive information intended for one user was redirected to another user, who may not have been an intended recipient. Tasks can be assigned to recipients who are not qualified to perform them. For example, in the healthcare industry, the advent of the Health Insurance Portability and Accountability Act of 1996 (HIPAA) made this a serious concern, as the penalties for inappropriate access of medical records increased dramatically.

### BRIEF DESCRIPTION OF THE DRAWINGS

FIGS. 1A and 1B are flowchart representations of a basic overview of a recipient-determined method for sharing tasks.

FIG. 2 is an embodiment of a potential design of a user.

FIG. 3 is a flowchart representing a workflow for working with a linked copy of messages and tasks of a covered.

FIG. 4 is a flowchart representation of an embodiment illustrating some steps utilized to create a linked copy to a covered user's unfinished tasks.

FIG. 5 represents a workflow for users to schedule occasions when their work will need to be covered.

FIG. 6 is an embodiment of a workflow for administrators to schedule occasions when users under their supervision will be unavailable and will require their work to be covered by.

FIG. 7 is a flowchart representation of some of the steps required to share tasks.

FIG. 8 is a flowchart representation of the role of security settings in determining the content of linked copies of covered users' tasks.

### DETAILED DESCRIPTION OF THE PREFERRED EMBODIMENTS

A number of design difficulties are resolved by a system developed in accordance with the following embodiments. Several drawbacks existed in association with the redirection model found in the prior art systems. Redirection may be described as an electronic messaging and workflow system where surrogate users receive messages and tasks that were assigned to another user, rather than preserving ownership of messages and tasks by the user originally intended to complete the message or task. For the purposes of this description, surrogate users are users capable of accessing the messages and tasks of a covered user through a linked copy. Additionally, a covered user may be a user who is absent from work or otherwise unable to complete all work assigned. A covered user's messages and tasks are included in linked copies so that surrogate users can complete them.

A linked copy is a folder containing copies of messages and tasks sent to a covered user and included in a folder in the user interface of surrogate users. It should be noted that the linked copy may not comprise a physical copy of the unfinished task, but may comprise only a link to an original unfinished task that was assigned to the covered user. Linked copies may appear as a node on the first level of a tree control, and may be named after the covered user. For example, if John Doe is absent from work, and Jane Doe is assigned as a surrogate user, the tree control in Jane Doe's interface contains a linked copy of John Doe's messages and tasks, in a folder marked “John Doe.”

Tree control is a method of navigating arrangements of data where virtual folders are displayed on a vertical framework. A common example of a tree control is the left pane of the Windows Explorer window. Folders on the tree control may be called nodes. In an acceptable interface for use in the disclosed embodiments, a tree control may be used to select messages or tasks. The first folder/node of the tree control may represent the recipient. Each user may have a folder on the tree control containing messages sent to the user. Additional folders may contain messages sent by the user and the results of searches for messages. Each Linked Copy may be created as an additional folder. The second layer of the tree control may represent the type of message. Each type of message may have a separate folder. Also, a node is a folder located on a tree control. Nodes may also be expanded to display any sub-nodes or files in the folder. It will be appreciated by those skilled in the art that the precise design and configuration of the user interface is not critical and, in fact, any type of user interface may be used. For example, the user interface may be configured to utilize ‘drop-down’ or ‘pull-down’ menus.

A redirection model is based on the definition of redirection and comprises an electronic messaging and workflow system that facilitates the sharing of work using methods of transferring that work from the covered user to surrogate users, particularly the forwarding of incoming messages from a covered user to surrogate users. A recipient determined model is a significant improvement over the redirection model. The term recipient-determined describes an electronic messaging and workflow system where the messages and tasks performed by surrogate users are determined by the surrogate users, instead of the covered user, supervisor, or system. Therefore, a recipient-determined model comprises an electronic messaging and workflow system that facilitates the sharing of work by allowing surrogate users to access the messages and tasks of the covered user and select which messages and tasks they should complete. Additionally, in such a system, messages are often regarded as a type of task, which may be completed by indicating that the recipient has read the message. More sophisticated tasks may include links to specialized interfaces in associated software packages, collections of data to approve, or other features.

It should also be noted that for the purposes of this description, the term “occasion” describes a scheduled range of time when a linked copy of a covered user's messages and tasks is generated for surrogate users. The covered user or a supervisor with appropriate security may create an occasion. Occasions are defined by a covered user, a reason for the occasion, a beginning and ending date and time, and a list of surrogate users.

As previously mentioned, several drawbacks existed in association with the redirection model. By disregarding the condition of surrogate users, systems based on the redirection model created difficulties for both surrogate users and covered users. Surrogate users were summarily assigned additional work, without regard to their own workload or area of expertise, while covered users lost the ability to monitor what work was being redirected. Work was not effectively shared, since it was merely passed along to surrogate users. Covered users lost ownership, and often awareness, of work sent to them, but completed by a surrogate.

A related issue to the loss of ownership of redirected work is loss of awareness of the issues dealt with by messages or tasks handled by surrogate users. A user who addresses most of a project but has a surrogate deal with a crucial task in the middle of it loses connection to the entire project, and may not even be aware that the task was completed, or how it was done. To address these concerns in the disclosed embodiment, ‘covered work’ messages may be electronically created. These messages may be sent automatically to covered users upon completion of any message or task by a surrogate. Depending on the type of message or task completed, a covered work message may provide a minimum of information, such as the message or task and the surrogate user who completed it, or it may allow the covered user to view, in detail, the operations performed by the surrogate user. The primary solution is that the covered user is aware of all messages and tasks sent to him, and aware of their completion.

Users of the electronic messaging/workflow system in prior systems were notified of the arrival of new messages and tasks by a number of alerts built into the interface. These alerts allowed users to recognize that a new message or task had arrived, to determine what type of message or task it was, to evaluate its priority, and then could decide to launch the electronic messaging/workflow system and address the actual content of the message or task. However, the alerts only functioned for messages and tasks sent to the user either directly or by redirection from a covered user. In the disclosed embodiment, however, the alerts may be modified to display information regarding messages sent to the user directly or to a linked copy of a covered user's messages and tasks.

The design of the security features necessitated a number of creative solutions. Some development was driven by HIPAA requirements. Specifically, while §164.508 and §164.510 establish requirements for obtaining consent and authorization forms prior to disclosing protected health information, the minimum requirements in §164.514 (d) allows for such information to be disclosed according to roles assigned to employees of the healthcare organization. In the disclosed embodiment, roles are assigned to users as security classes, and a security class was developed to control user access to the system.

While the concept of a security class in general as well as other security measures are not particular to the embodiments of the invention, the details of those elements of security pertaining to the invention are described herein. A new security class was created for the entire advanced electronic messaging/workflow system, as shown in the disclosed embodiment, and elements of the security class were specifically designed to govern the operation of such a system. Those elements are described below.

Each security class may contain a list of the types of messages and tasks that are available to users assigned to the class. In the event that a surrogate user gains a linked copy of the messages and tasks of a covered user, and if that user had been sent messages or tasks not included in the surrogate user's list, those messages do not appear in the surrogate user's linked copy. Individual users may be granted access to additional types of messages or tasks.

At the system level, a similar list of types of messages and tasks may be recorded. These messages and tasks may not be included in any linked copy of a covered user's messages and tasks. This security feature may be used to prevent the ‘covered work’ messages from appearing in linked copies.

Each security class may contain a list of security points, which control access to the system. The security points have the following functions: (1) Allow surrogate users to choose which linked copies of the messages and tasks of covered users are visible. (2) Allow users to choose additional users to cover. The user may become a surrogate user for the covered user and a linked copy of the covered user's messages and tasks may appear for the user. Due to interface design, this security point may require that the previous security point be assigned. (3) Allow users to view occasions when users are scheduled to be covered, and create their own occasions. Users can view, for example, occasions based on the covered user, the time of the occasion, reasons for the occasion, and which surrogate users are designated. (4) Allow users to view occasions when users are scheduled to be covered, and create occasions for any other user. This security point may require that the previous security point be assigned.

Each user can have an individualized set of additional security points and other settings, controlling how messages and tasks appear to that user, which options the user has for responding to those messages and tasks, and various other features. When dealing with messages or tasks selected from a linked copy of a covered user's messages and tasks, surrogate users interact with the message as though it were sent to them, using their own settings. As a result, surrogate users may not gain access to tasks they are not normally allowed to complete, nor may they view information they are not normally allowed to see.

Two major components of the system presented in the disclosed embodiment can be identified, and the integration of these components is encompassed therein. The disclosed embodiment also encompasses various security measures governing the function of the components.

The first component is the creation of a linked copy of the tasks assigned to the absent or overburdened user such that it is easily accessible to surrogate users who are completing those tasks. It will be appreciated that it may be possible to attach a plurality of users' messages to a surrogate user. Depending on the level of security assigned, a surrogate can assume an active stance and create a linked copy of another user's tasks by selecting a user from a list of available users. In other words, surrogate users can manage their workloads by determining which linked copies of covered user's messages and tasks appear in their interface. In essence, users can designate themselves as surrogates for other users. Also, surrogate users can identify/discern which messages and tasks are sent to them directly, and which are sent to a covered user, and which covered user is the recipient.

In the disclosed embodiment, the linked copy of tasks appears in a separate directory, which may be accessed through a node on a tree control, where other nodes of the tree correspond to a directory of tasks assigned directly to the surrogate user, and a directory of tasks generated by the surrogate user. Each linked copy may appear as a separate node, and may be identified with the name of the user being covered by the surrogate user. It should be understood that many other techniques are also available, including variations of node control, such as, for example, configuring each message type as its own first level directory.

The second component is the ability to create ‘occasions’ when a user is unavailable and needs his work to be covered by surrogate users. These occasions can be scheduled in advance, such as for a vacation, or can be created on-the-fly, as for an unexpected absence for an illness. Depending on a user's security, users can either create their own occasions, or a supervisor can create the occasions for them. Occasions are assigned to the user who will be unavailable, and record a range of time when the user will be covered, a list of surrogate users to cover for the user, and a reason for the occasion.

During one of these occasions, surrogate users designated for the occasion may automatically have a linked copy of the covered user's messages and tasks appear in their user interface. In other words, linked copies of covered user's messages and tasks are generated for each surrogate user, based on the security settings established for the overall system, the role assigned to the user, and the user as an individual. Surrogate users can then begin working on the covered user's tasks, from roughly the same context as the covered user would. The system may provide visual alerts to draw attention to messages and tasks that are sent with a high-priority flag, or that are flagged as having an abnormal result, and these alerts may be active for both messages and tasks sent to the user directly, and messages and tasks sent to the covered user. Any messages that the covered user might have relating to the tasks are available to the surrogate users. The list of messages and tasks in the linked copy may be routinely updated, so that progress made on a task by one surrogate user is communicated to other users, and tasks completed by one surrogate user are removed from the linked copy of all surrogate users. This prevents surrogates from duplicating work, as in a case where two surrogate users are working on the same task without being aware of the other, as can occur in redirection-based systems.

Whenever a surrogate user completes a task for the covered user, an electronic message may be sent to the covered user, informing him of the action. This message may not appear in the linked copy of the covered user's messages and tasks.

In systems implemented in accordance the embodiments disclosed in this patent, users are able to schedule multiple occasions when they will be unavailable, alerting surrogate users to their coverage needs ahead of time. Supervisors are able to build schedules that incorporate these occasions, and can create them as needed to respond to unexpected outages. The ability to share work is expanded throughout the suite of applications offered by the inventing company, as it is based on a complete set of message types.

Using a recipient-determined model, work can truly be shared. Recipients can choose which tasks they are best able to address, and work on them. Surrogate users can focus on more urgent concerns for themselves or for covered users. If multiple surrogates are assigned to a covered user, work done by one surrogate is removed from all surrogates, so that effort is not duplicated. Thus, multiple surrogate users can divide the covered user's work amongst themselves without duplicating each other's effort. Tasks that are not covered by a surrogate user while the covered user is unavailable are available for both users when the covered user returns.

Various embodiments of a recipient-determined method for sharing tasks may also include the capability of creating multiple groups of surrogates for each covered user. These embodiments may also include the intelligence to examine a covered user's unfinished task and create a link for only the surrogates in the appropriate surrogate group.

The enhanced security model allows surrogate users to operate as though they had the task assigned to them, using the interface as it is configured for them. Surrogate users cannot receive inappropriate messages or be given inappropriate tasks.

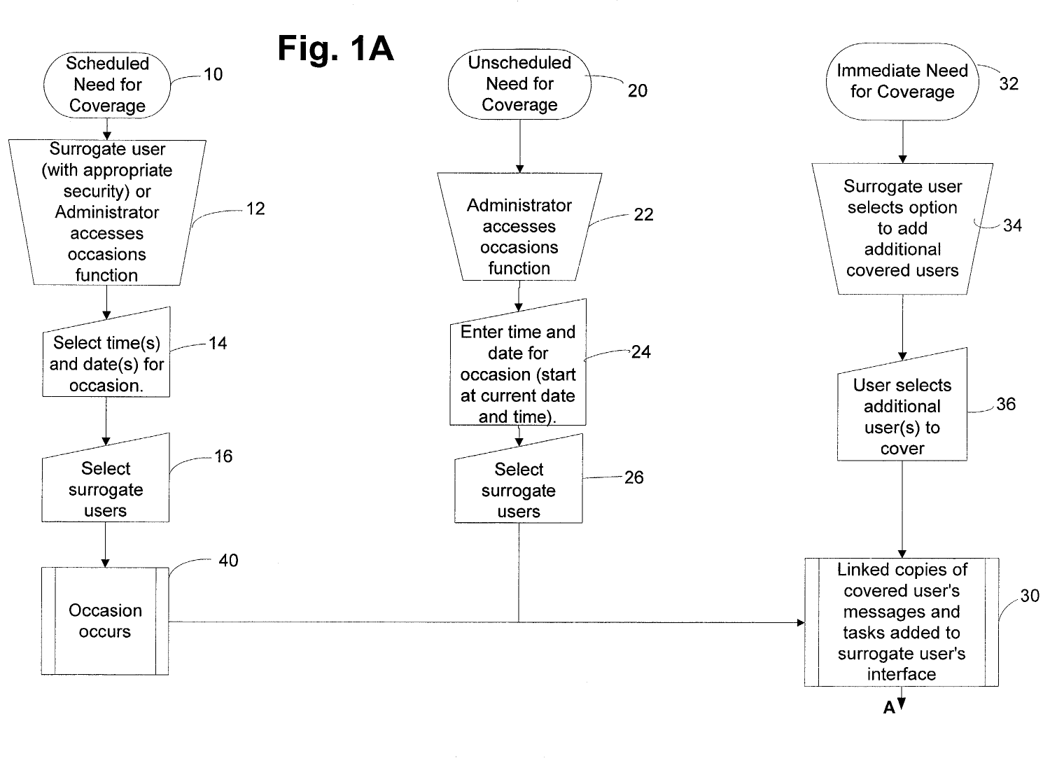

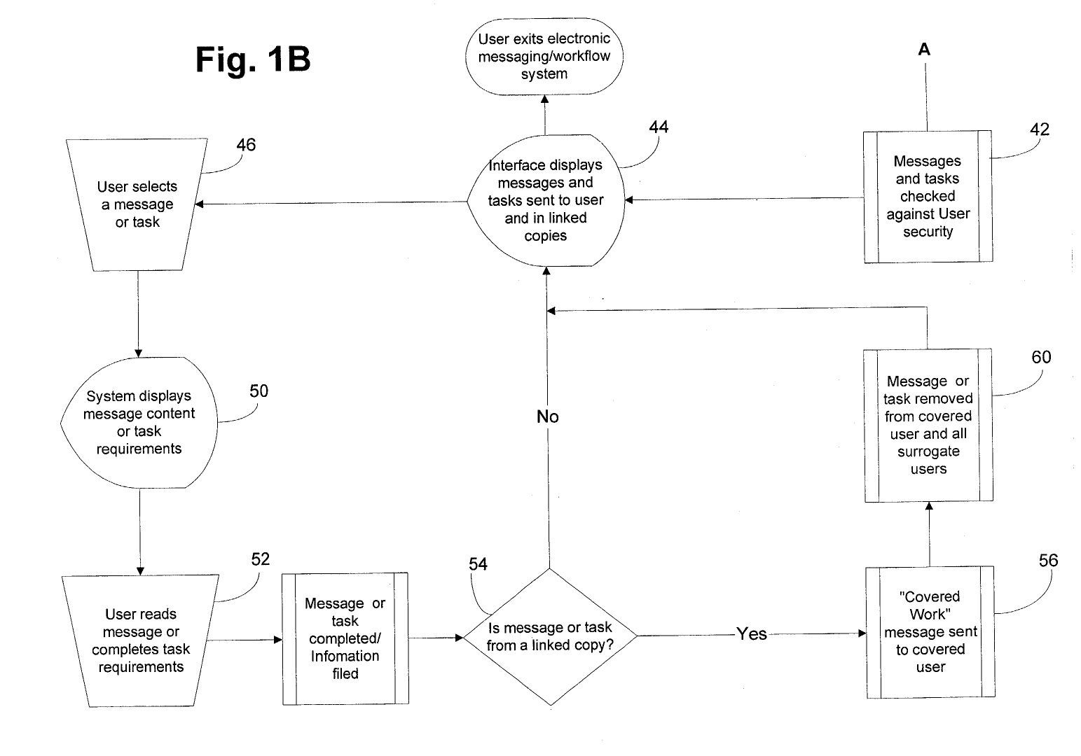

FIGS. 1A and 1B represent a basic overview of a recipient-determined method for sharing tasks in an advanced electronic messaging/workflow system capable of addressing various scenarios in which users are unable to perform their work. A block 10 illustrates the initiation of a scheduled need for coverage. A scheduled need for coverage may also be described as an event where a user is aware of an upcoming occasion requiring coverage of messages and tasks, such as a vacation. When such an occasion is scheduled, as shown at a block 12, the user (assuming appropriate security) or an administrator (also with appropriate security) may access an occasion function in a messaging/workflow system. At a block 14, the user or administrator may record the time and reason for the occasion. The time of the occasion may include only a start time, or it may also include a specific end time for the occasion. The user or administrator may also select one or more surrogate users to cover work during that occasion, as shown at a block 16.

A block 20 illustrates the initiation of an unscheduled need for coverage. If the need for coverage is unscheduled, as in an absence due to illness, at a block 22 an administrator may access an occasion function in a messaging/workflow system. Thereafter, at a block 24, the administrator may create an occasion by entering an end time and date for the occasion, such as a start with the current date and time. At a block 26, the user may select one or more surrogate users for the occasion. By creating an occasion beginning at the current time, the surrogate users selected may immediately receive a linked copy of the covered user's messages and tasks. This is shown at a block 30.

A block 32 illustrates an immediate need to cover another user, such as an overburdened user requesting help, or a number of users deciding to share work amongst themselves. In this situation, as shown at a block 34 and a block 36 users can, with appropriate security, choose to become a surrogate for another user. In this instance, no occasion is created; the system simply creates a linked copy of the covered user's messages and tasks for the surrogate user. This functionality may also be described as creating an occasion comprising an indefinite end time.

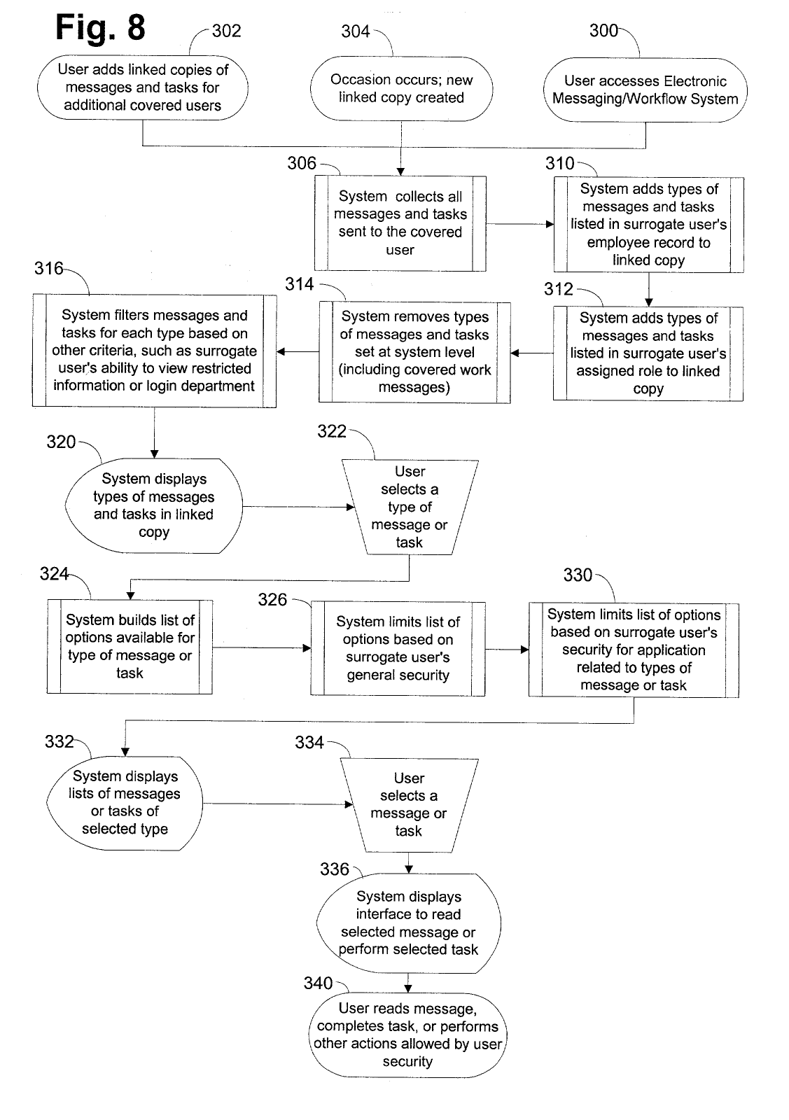

Once the scheduled occasion occurs, as seen in a block 40, or immediately, in the next two scenarios, a linked copy of the covered user's messages and tasks is created for each surrogate user at the block 30. As shown in FIG. 1B at a block 42, the surrogates' link to the covered user's tasks may be based on the security of the surrogate users. (See FIG. 8 for a more complete look at the role of security settings.) Surrogate users can then read messages and perform tasks assigned to the covered user. This is shown at a block 44 where an interface may display both the tasks sent to the user and links to the tasks assigned to the covered user. At a block 46, the user may select a task from the unfinished tasks assigned to the covered user. The surrogate user may decide to select a specific task for a variety of reasons, such as the task having a high priority to complete, the user being well informed or qualified to complete the task, etc. Selecting the task may be accomplished by selecting the link to the selected task with the use of a peripheral device, such as a mouse for example. The system may then display a message content or a task requirement, as seen at a block 50. At a block 52, the surrogate user may read the message or complete the task requirements.

If the task completed was not from a link to a covered user's task, then a block 54 redirects the system back to the display of messages and tasks in the interface at the block 44. However, if the task completed was from a link to a covered user's task, then the block 54 directs the system to a block 56 where a covered work message is sent to the covered user to notify that covered user of the work done on that covered user's behalf. The covered work message may comprise only a notification that the task was completed, or it may contain a great deal more information, such as a detailed analysis of all the work or steps performed by the surrogate user to complete the task. The completed message or task is then removed from the interfaces of the covered user and all surrogates. This is shown at a block 60.

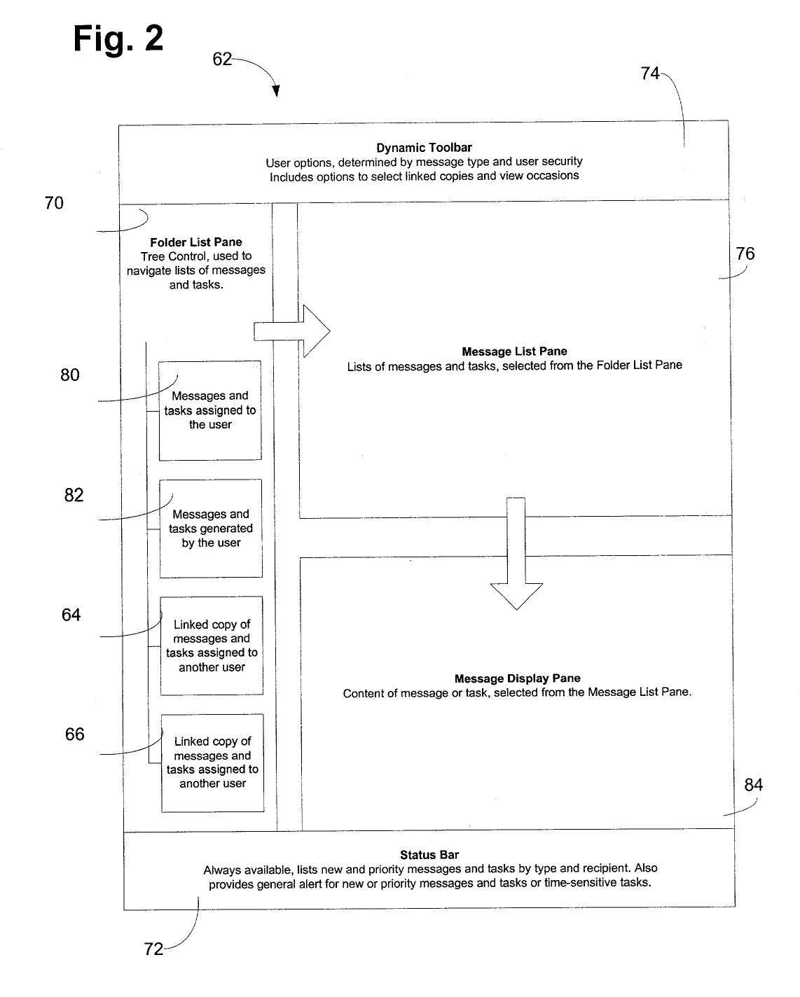

FIG. 2 is an embodiment of a potential design of a user interface 62 for a workflow sharing system. This diagram may be utilized as an interface 62 to select linked copies, select types of messages or task from the linked copy, and view information about selected messages or tasks. The interface 62 may behave identically for messages and tasks of the same type, regardless of whether they were sent to the user directly, or if the user accesses them from a linked copy of another user's messages and tasks.

In the embodiment of FIG. 2, a first linked copy 64 and a second linked copy 66 of the covered user's messages and tasks may be located on the Folder List Pane section, which is a section 70 of the interface 62. Each linked copy 64 and 66 may be identified by the name of the covered user. It is also important to note that a Status Bar 72 may provide information about messages and tasks sent directly to the user, as well as about messages and tasks sent to any covered users. For example, if the rest of the user interface is closed or minimized, the status bar may remain visible at the bottom of the display to provide updates on alerts, notification of new tasks, etc. The system may be configured to allow the alerts to provide a navigation method to access the tasks.

A Dynamic Toolbar 74 may contain the buttons used to access a multitude of functions. One button may open a separate window over the interface 62 allowing users to designate themselves as surrogate users for other users, and determine which available linked copies appear in their Folder List pane 70. Another button may open a different window, allowing users to view existing occasions, create new occasions for themselves or other users, edit existing occasions, or delete occasions. For each type of message selected in a Message List Pane 76, the options on the toolbar 74 change according to the message type and the user's security. Different options are available for different types of tasks, usually offering user's access to other features of the software package that are used to complete the task.

The Folder List Pane 70 may also contain links to the covered users' messages and tasks. Selecting a folder (the user's own messages and tasks 80, messages and tasks sent by the user 82, or a linked copy of another user's messages and tasks 64 or 66) may display the types of messages and tasks below that folder in the Folder List Pane 70. Selecting a type of message or task in the pane 70 may cause the individual messages or tasks of that type to be listed in the Message List Pane 76.

The Message List Pane 76 displays lists of selected messages or tasks, based on the type selected in the Folder List Pane 70. Selecting a message or task from pane 70 may cause the information contained in that message or task to be displayed in a Message Display Pane 84 for most messages and tasks. Some tasks are associated with a specific feature of the software package that is used to complete the task, and selecting a task may immediately access that feature so that the user can complete the task.

The Message Display Pane 84 may present information about the message or task selected in the Message List Pane 76. In the case of messages, the content of the message is displayed in Pane 84. Tasks may display a message indicating work to be done, with various links to related information or software features, as needed to complete the task. Also, as previously mentioned, the term task is intended to encompass messages as well as tasks.

As shown in FIG. 2, the Status Bar 72 may be continuously available in the interface 62 containing the electronic messaging/workflow system and a variety of other software features related to the types of tasks dealt with by the electronic messaging/workflow system. It may provide a general alert, a specialized alert for time-sensitive tasks, and specific alerts for types of messages or tasks with new messages or tasks. Alerts for new messages sent to the surrogate user directly or through a linked copy may be integrated to provide equivalent notification to surrogate users.

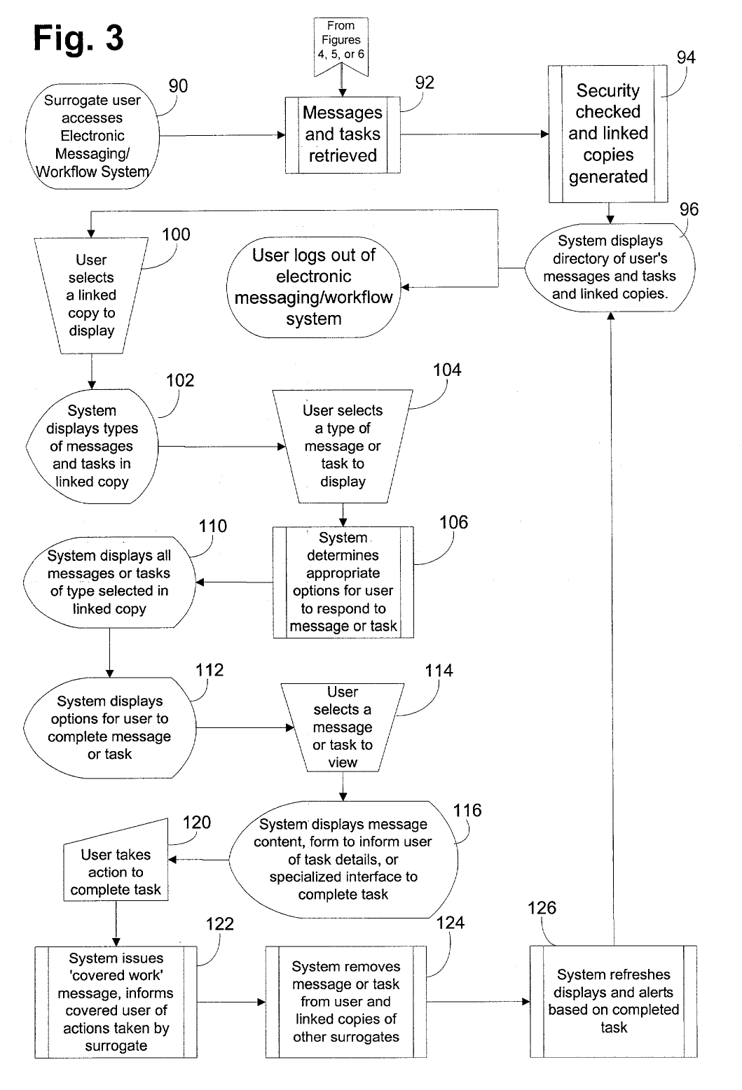

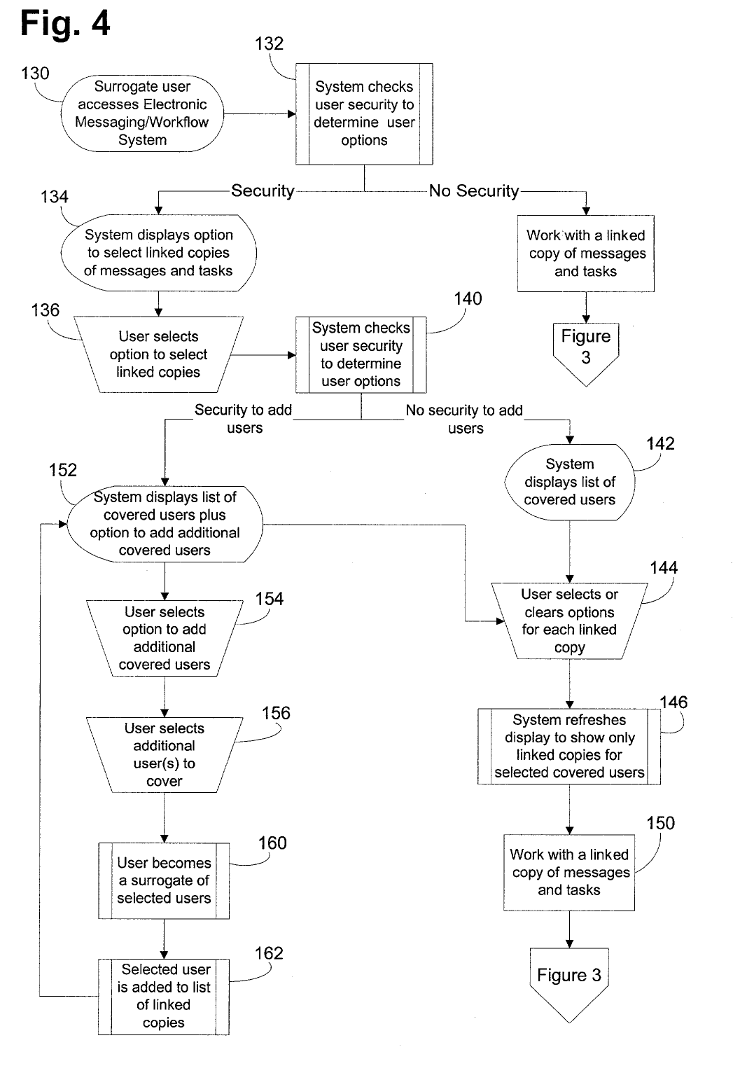

FIG. 3 is a flowchart representing a workflow for working with a linked copy of messages and tasks of a covered user in a system based on the recipientdetermined model for sharing work.

When a surrogate user accesses the electronic messaging/workflow system at a block 90, that user's own messages and tasks may be retrieved from a central database at a block 92, along with the messages and tasks in any linked copies. At a block 94, the user's security may be checked to limit the types of messages and tasks available to the user. The approved types of messages may then be displayed at a block 96.

Assuming that the user selects a linked copy of a covered user's messages and tasks, as shown at a block 100, the system may then display at a block 102 the types of messages and tasks available to the surrogate user. At a block 104, the user may select a type of message or task, which may then be displayed at a block 106. At this point, the system configures the dynamic toolbar based on what options the type of message or task requires and what options are allowed based on the user's security. At a block 106, the system determines the appropriate options for the user to respond to the task. The system may then display at a block 110 all the messages or tasks of the type selected in the linked copy. The system may then display the options for the user to complete the message or task, as shown at a block 112. As shown at a block 114, when the user selects a specific message or task to view, the system either displays the content of the message or task, or opens a specialized window to allow the user to complete the task. As shown at a block 116, the specialized window may also be referred to as a specialized interface.

Once the user has done whatever is necessary to complete the selected message or task (a block 120), the user informs the system, if necessary. (Completing a message may be accomplished by reading the message and marking it as having been read; it is equivalent to a task of reading the message, which is why messages may be referred to as tasks.) At a block 122, the system may then generate a ‘covered work’ type of message and send it to the covered user when the surrogate user completes the unfinished task. At a block 124, the system may then remove the completed message or task from the interfaces for the covered user and all surrogate users. In other words, the link to the task is removed upon completion of the task. As shown at a block 126, the system may then refresh displays and alerts to reflect that the message or task has been completed.

Once the message or task has been completed or processed by the system, the user can continue to complete messages or tasks, or leave the electronic messaging/workflow system, or detach one or more covered users' messages.

FIG. 4 is an embodiment illustrating some steps utilized to create a linked copy to a covered user's unfinished tasks. Additionally, this diagram represents a workflow used by users to designate themselves as surrogate users for another user in a system based on the recipient-determined model for sharing work.

At a block 130, users wanting to cover the work of an absent or overburdened user can access the electronic messaging/workflow system. The system may perform a first security check at a block 132 to determine if the user has sufficient security to be made aware of the advanced option. If the user has sufficient security, at a block 134, the system may display to the user the option to select linked copies of messages and tasks. The user may then choose the option to select linked copies, as shown at a block 136.

At a block 140, the system may then check the user's security to determine the options available to the user. If the user does not have the required security, the system displays a list of the covered users at a block 142. At a block 144, the user may be given the option to select which linked copies appear in their interface. Once they select this option, they can see which users have them listed as surrogates. If the absent or overburdened user is on this list, they can select that user and accept the window. At a block 146, the system may create a new linked copy based on user and system security and refresh the interface to include the new linked copy. As shown at a block 150, the user may then work with a linked copy of messages and tasks.

If the absent or overburdened user does not appear on the list, and the users have additional security clearance, the system may display at a block 152, a list of covered users plus the option to add additional covered users. At a block 154, the user may select an option to add additional covered users. At a block 156, the users may select the additional user(s) to cover.

By selecting this option and choosing the absent or overburdened user, they can become surrogates for that user. This is shown at a block 160. At a block 162, the absent or overburdened user is added to the list of covered users, and is automatically selected to have a linked copy included in the interface. When the surrogate users accept the window, the system creates the new linked copy of the selected user's messages and tasks, based on user and system security, and refreshes the interface to include the new linked copy. The interface may further be periodically updated to indicate progress made on the unfinished task. Once the new linked copy is created, users can deal with the messages and tasks in it as in FIG. 3.

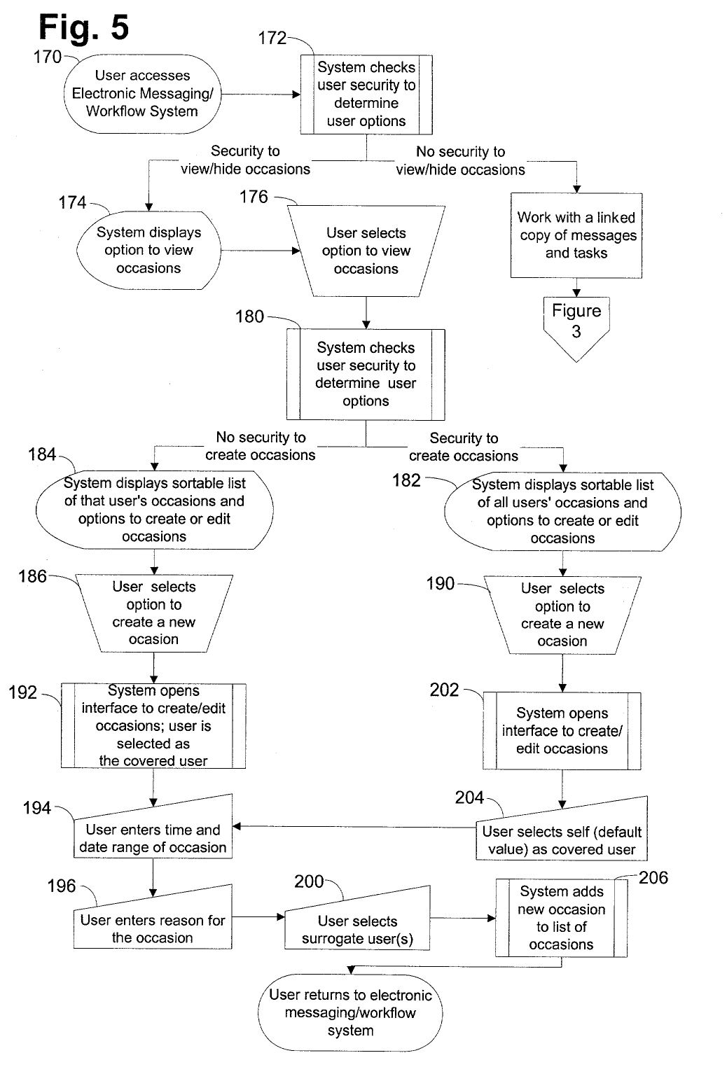

FIG. 5 represents a workflow for users to schedule occasions when their work will need to be covered in a system based on the recipient-determined model for sharing work.

When users know they will be unavailable at some future time, or wish to share their work with another user, they can access the electronic messaging/workflow system at a block 170. The system may then perform a security check at a block 172 to determine if the user has the appropriate security to view/hide occasions requiring user coverage. If they have appropriate security, at a block 174, the system may display the option to view one or more occasion. If at a block 176, the user selects the option to view an occasion, the system may check at a block 180 to determine the options available to the user. If they have the appropriate security, at a block 182 the system may display a sortable list of occasions. This list may contain occasions for all users, as well as the option to create or edit an occasion. If the user does not have the appropriate security to create occasions for other users; at a block 184, the system may display a sortable list of only that user's occasions and the option to create or edit occasions. In either case, there is an option to create a new occasion. This is shown at a first block 186 and a second block 190.

Following the block 186 is a block 192, wherein the system opens the interface to create or edit one or more occasion. In this block, the user may be selected as the covered user. At a block 194, the users may enter the time and date to begin and end the occasion. The user may then enter a reason for the occasion at a block 196, and then select surrogate users for the occasion at a block 200. If the users have security to create occasions for other users, the system may open the interface to create or edit an occasion at a block 202. Then, at a block 204, a user may accept the default value of himself as the covered user. Otherwise the covered user is not editable and there is no option to select another user.

Once the new occasion is accepted, it may be recorded. Then, at a block 206, the list of existing occasions may be updated when the system adds the new occasion to the list of occasions.

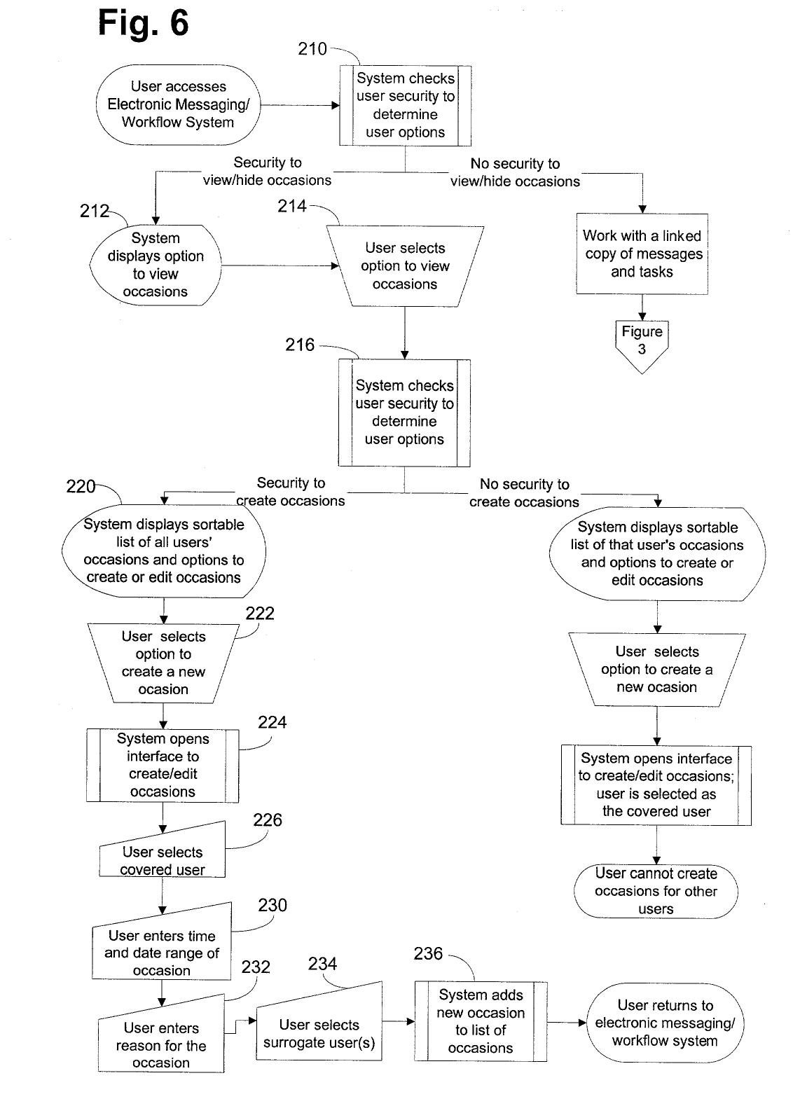

FIG. 6 is an embodiment of a workflow for administrators to schedule occasions when users under their supervision will be unavailable and will require their work to be covered by others, in a system based on the recipient-determined model for sharing work.

If the user passes the first security check at a block 210, the system may display the option to access the occasion routine for the user, as shown at a block 212. When users know another user will be unavailable at some future time, or they supervise a user who is unexpectedly absent, but for a known length of time, they can access the electronic messaging/workflow system at a block 214. Assuming they have appropriate security when the system performs a security check at a block 216, they may have the option to view existing occasions. Once they select this option at a block 220, they may see a list of existing occasions. At the block 220, the system may display a sortable list of all users' occasions and options to create or edit occasions. Again assuming they have appropriate security, this list may contain occasions for all users. An option to create a new occasion is also provided at a block 222. After the users select the option to create a new occasion, the system may open an interface to create or edit occasions at a block 224.

To create the occasion, users may enter the user to be covered during the occasion at a block 226. The users may also enter at a block 230 the time and date to begin and end the occasion, as well as entering at a block 232 a reason for the occasion. At a block 234, the users may select surrogate users for the occasion. Once they accept the new occasion, it may be recorded and the list of existing occasions updated at a block 236.

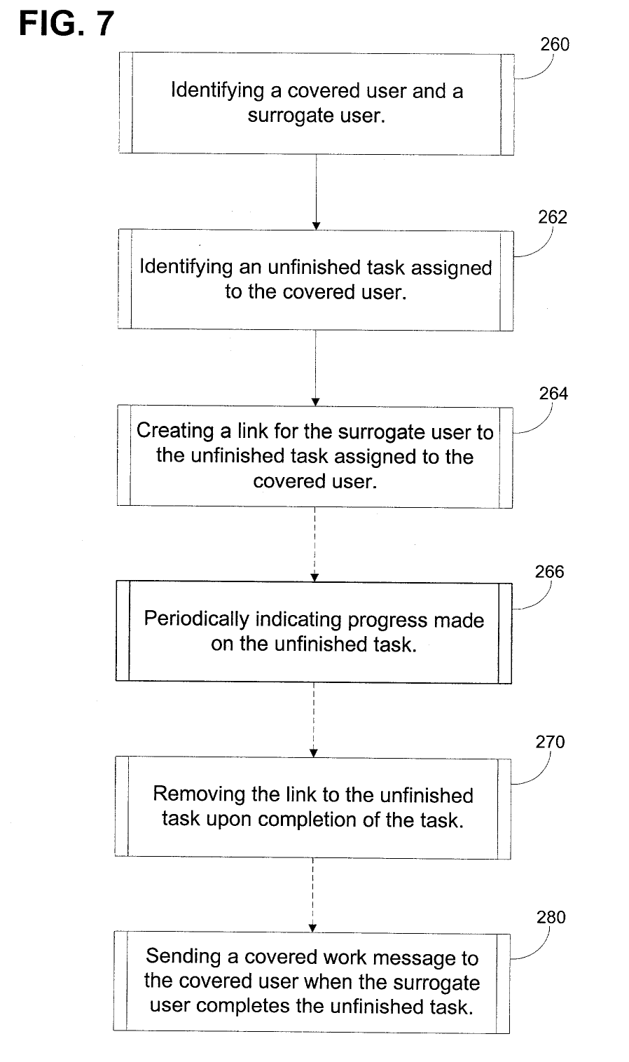

FIG. 7 is a flowchart representation of some of the steps utilized in sharing tasks in accordance with an embodiment of the invention. A block 260 includes identifying a covered user and a surrogate user. At a block 262, an unfinished task that is assigned to the covered user is identified. A block 264 next includes creating a link for the surrogate user to the unfinished task assigned to the covered user. Additional blocks may also be added, but are not necessary. For example, a block 266 may include periodically indicating progress made on the unfinished task. After indicating progress made on the unfinished task, a block 270 may comprise removing the link to the unfinished task upon completion of the task. And lastly, a covered work message may be sent to the covered user when the surrogate user completes the unfinished task.

FIG. 8 provides a more complete view of the role of security settings in determining the content of linked copies of covered user's messages and tasks and determining the abilities of surrogate users to work with messages and tasks in linked copies.

When a user accesses the electronic messaging/workflow system at a block 300, or becomes a surrogate for a new user at a block 302, or when an occasion adds a new covered user to a user at a block 304, or some other event causes a linked copy to be created, the system may collect all messages and tasks sent to the covered user and may prepare to create the surrogate user's linked copy of those messages and tasks at a block 306. At a block 310, the system may add all messages and tasks of types specified in the surrogate user's employee record. Various security classes are available for each area of software functionality, and are used to assign roles to users when using that portion of the software. These roles can allow the user to receive additional types of messages and tasks, or can prevent users from receiving messages based on their department or other locator. All messages and tasks of types specified in the role assigned to the user may also be added to the linked copy at a block 312.

At the system level, some types of messages or tasks can be excluded from linked copies, such as the ‘covered work’ messages. These types of message and tasks may be removed from the linked copy at a block 314. A final filter may be run over individual messages, based on the user's security record at a block 316. Primarily, this is used to prevent users who lack a security setting from receiving messages with ‘restricted’ data. An example of when this may be useful is in the healthcare industry, where users can have information about certain patients or members forbidden to them, based on individual patients or members, or on the location of those patients or members. Messages and tasks related to such patients or members may be eliminated from the linked copy.

At a block 320, the system may display types of messages and tasks in linked copies. As a user works with a linked copy of messages and tasks, additional security checks may be performed. When the user selects a type of message or task from a linked copy at a block 322, the message type may be checked at a block 324 to build a list of options that are available to the user. In addition to general message management activities (such as forwarding messages, attaching flags to messages, or postponing messages), many tasks provide specialized options for completing the task. In a general security class assigned to the user, the ability to perform certain message management activities can be restricted at a block 326. Any disallowed actions may be removed from the list at a block 330. Most types of messages and tasks are associated with a particular area of software functionality, and a user's security for that area of functionality can limit the availability of certain options. These options are also removed from the list. Finally, the remaining items on the list may be presented to the user at a block 332. The user can then use these options to complete the messages and tasks of the selected type.

When a user selects a particular message or task at a block 334, the type of message may again be checked to see what information is available to the user. The message or task may either display information in a Message Display pane, open a specialized interface for completing the message or task, or open a portion of the software related to the message or task at a block 336. Then at a block 340, the user may read a message, complete a task, or perform other actions that are allowed by the user's security.

Although the technique for sharing tasks described herein is preferably implemented in software, it may be implemented in hardware, firmware, etc., and may be implemented by any other processor associated with the organization. Thus, the routines described herein may be implemented in a standard multi-purpose CPU or on specifically designed hardware or firmware as desired. When implemented in software, the software routine may be stored in any computer readable memory such as on a magnetic disk, a laser disk, or other storage medium, in a RAM or ROM of a computer or processor, etc. Likewise, this software may be delivered to a user or a process control system via any known or desired delivery method including, for example, on a computer readable disk or other transportable computer storage mechanism or over a communication channel such as a telephone line, the internet, etc. (which are viewed as being the same as or interchangeable with providing such software via a transportable storage medium).

The invention has been described in terms of several preferred embodiments. It will be appreciated that the invention may otherwise be embodied without departing from the fair scope of the invention defined by the following claims:

1. A method for sharing tasks, comprising:
identifying a covered user, wherein the covered user is assigned one or more tasks;
identifying a surrogate user that is associated with the covered user;
identifying an unfinished task from the one or more tasks assigned to the covered user;
creating a link for the surrogate user to the unfinished task assigned to the covered user; and
providing the ability for the surrogate user to access the unfinished task via the link.

2. The method of claim 1, further comprising the step of periodically indicating progress made on the unfinished task.

3. The method of claim 1, further comprising the step of removing the surrogate user's link to the covered user's unfinished task upon completion of the task by either the surrogate user or the covered user.

4. The method of claim 1, wherein the step of creating the link for the surrogate user comprises visually depicting the unfinished task as a separate node.

5. The method of claim 1, further comprising the step of providing an alert for a high priority task.

6. The method of claim 1, wherein the step of creating the link for the surrogate user is performed for a fixed time period having a start time and an end time.

7. The method of claim 1, further comprising the steps of creating an occasion requiring coverage for the covered user and removing the surrogate user's link to the covered user's task when the occasion expires.

8. The method of claim 7, wherein the occasion comprises a fixed period of time having a start time and an end time.

9. The method of claim 7, wherein the occasion comprises a start time and an indefinite end time.

10. The method of claim 7, wherein the step of creating the occasion is performed in advance by the covered user to schedule a planned inability of the covered user to complete the unfinished task.

11. The method of claim 7, wherein the step of creating the occasion is performed by an administrator to respond to an unplanned inability of the covered user to complete the unfinished task.

12. The method of claim 1, further comprising the step of assigning a security class to the surrogate user, wherein the security class comprises a list of tasks that are available to the surrogate user.

13. The method of claim 12, further comprising the step of checking the security class of the surrogate user before creating the link to the unfinished task to prevent the surrogate user from receiving a link to a restricted task.

14. The method of claim 13, further comprising the step of checking the security class of the surrogate user before allowing the surrogate user to review the information associated with the unfinished task to prevent the surrogate user from reviewing restricted information.

15. The method of claim 1, further comprising the step of sending a covered work message to the covered user when the surrogate user completes the unfinished task.

16. The method of claim 15, wherein the step of sending the covered work message to the covered user includes sending an explanation of the operations performed by the surrogate user after completing the unfinished task.

17. The method of claim 1, wherein a plurality of unfinished tasks assigned to the covered user exists, and wherein the step of identifying the unfinished task includes identifying the plurality of unfinished tasks.

18. The method of claim 17, further comprising the step of allowing the surrogate user to select an unfinished task from the plurality of unfinished tasks for completion.

19. A method for sharing tasks, comprising:
identifying a covered user and a surrogate user;
identifying an unfinished task assigned to the covered user;
creating a link for the surrogate user to the unfinished task assigned to the covered user;
indicating progress made on the unfinished task; and
removing the link to the unfinished task upon completion of the task.

20. The method of claim 19, wherein the step of creating the link for the surrogate user comprises visually depicting the unfinished task as a separate node.

21. The method of claim 19, further comprising the step of providing an alert for a high priority task.

22. The method of claim 19, wherein the step of creating the link for the surrogate user is performed for a fixed time period having a start time and an end time.

23. The method of claim 19, wherein a plurality of unfinished tasks assigned to the covered user exists, and wherein the step of identifying the unfinished task includes identifying the plurality of unfinished tasks.

24. The method of claim 19, further comprising the steps of creating an occasion requiring coverage for the covered user and returning an uncompleted task to the covered user when the occasion expires.

25. The method of claim 24, wherein the occasion comprises a fixed period of time having a start time and an end time.

26. The method of claim 24, wherein the occasion comprises a start time and an indefinite end time.

27. The method of claim 24, wherein the step of creating the occasion is performed in advance by the covered user to schedule a planned inability of the covered user to complete the unfinished task.

28. The method of claim 24, wherein the step of creating the occasion is performed by an administrator to respond to an unplanned inability of the covered user to complete the unfinished task.

29. The method of claim 19, further comprising the step of assigning a security class to the surrogate user, wherein the security class comprises a list of tasks that are available to the surrogate user.

30. The method of claim 29, further comprising the step of checking the security class of the surrogate user before creating the link to the unfinished task to prevent the surrogate user from receiving a link to a restricted task.

31. The method of claim 29, further comprising the step of checking the security class of the surrogate user before allowing the surrogate user to review the information associated with the unfinished task to prevent the surrogate user from reviewing restricted information.

32. The method of claim 19, further comprising the step of sending a covered work message to the covered user when the surrogate user completes the unfinished task.

33. The method of claim 32, wherein the step of sending the covered work message to the covered user includes sending an explanation of the operations performed by the surrogate user after completing the unfinished task.

34. A method for sharing tasks, comprising: identifying a covered user and a surrogate user;
identifying a plurality of unfinished tasks assigned to the covered user;
creating a link for the surrogate user to the plurality of unfinished tasks assigned to the covered user;
removing the link to the selected task upon completion of the task; and
sending a covered work message to the covered user when the surrogate user completes the selected task.

35. The method of claim 34, further comprising the step of providing an alert for a high priority task.

36. The method of claim 34, wherein the step of creating the link for the surrogate user is performed for a fixed time period having a start time and an end time.

37. The method of claim 34, further comprising the steps of creating an occasion requiring coverage for the covered user and returning an uncompleted selected task to the covered user when the occasion expires.

38. The method of claim 34, further comprising the step of periodically indicating progress made on a task selected from the plurality of unfinished tasks.

39. The method of claim 34, wherein the step of sending the covered work message to the covered user includes sending an explanation of the operations performed by the surrogate user after completing the selected task.

40. The method of claim 34, further comprising the step of assigning a security class to the surrogate user, wherein the security class comprises a list of tasks that are available to the surrogate user.

41. The method of claim 40, further comprising the step of checking the security class of the surrogate user before creating the link to the plurality of unfinished tasks to prevent the surrogate user from receiving a link to a restricted task.

42. The method of claim 40, further comprising the step of checking the security class of the surrogate user before allowing the surrogate user to review the information associated with the plurality of unfinished tasks to prevent the surrogate user from reviewing restricted information.

43. A method for sharing tasks, comprising:
identifying a covered user and a surrogate user;
identifying an unfinished task assigned to the covered user;
assigning a security class to the surrogate user;
checking the security class assigned to the surrogate user;
creating a link for the surrogate user to the unfinished task assigned to the covered user;
removing the link to the unfinished task upon completion of the task; and
sending a covered work message to the covered user when the surrogate user completes the unfinished task.

44. The method of claim 43, further comprising the step of periodically indicating progress made on the unfinished task.

45. A computer routine for sharing tasks, comprising:
a first routine for identifying a covered user and a surrogate user;
a second routine for identifying an unfinished task assigned to the covered user;
a third routine for creating a link for the surrogate user to the unfinished task assigned to the covered user;
a fourth routine for periodically indicating progress made on the unfinished task;
a fifth routine for removing the link to the unfinished task upon completion of the task; and
a sixth routine for sending a covered work message to the covered user when the surrogate user completes the unfinished task.
